(19) United States
(12) Patent Application Publication
(10) Pub. No.: US 2006/0219301 A1
(43) Pub. Date: Oct. 5, 2006

(54) System and method for maintaining pressure and flow in a vent header

(76) Inventors: Kenneth E. Reid II, Oxford, AL (US); Frank A. Ruiz, Greenwell Springs, LA (US)

Correspondence Address: Renner, Otto, Boisselle & Sklar, 19th Floor, 1621 Euclid Ave., Cleveland, OH, 44115, US

(21) Appl. No.: 11/209,546

(22) Filed: Aug. 23, 2005

Related U.S. Application Data
(60) Provisional application No. 60/668,370, filed on Apr. 5, 2005.

(51) Int. Cl. F03B 11/02

(52) U.S. Cl. 137/561 R

(57) ABSTRACT

A system for maintaining a stable pressure in a process analyzer measurement cell using pneumatic components. The system comprises an eductor having a pressure passage, a discharge passage, and a suction passage, and an eductor flow regulator for regulating the flow of a motive gas to the pressure passage as a function of pressure in the suction passage or the discharge passage.

### RELATED APPLICATION

This application claims the benefit of U.S. Provisional Application No. 60/668,370 filed Apr. 5, 2005, which is hereby incorporated herein by reference.

### FIELD OF THE INVENTION

The present invention relates generally to gas processing systems. More particularly, the invention relates to a system and method for isolating a gas analyzer from downstream pressure and flow rate fluctuations that affect sample gas streams passing therethrough.

### BACKGROUND OF THE INVENTION

Gasses, which include effluent, exhaust, process types, and so forth, from both industrial and non-industrial applications are generally monitored to ensure that the concentration of certain constituents do not vary from predetermined limits. Gas analyzers are used to determine the concentrations of particular components, such as oxygen, carbon dioxide, carbon monoxide, and so forth, in a gas sample. In the analysis of gases, it is well known that measurements should be performed under stable operating conditions. Variations in flow rates, temperatures and pressures can negatively affect the performance of the analyzer. Even minor fluctuations can impair the functionality and thus affect the accuracy of the analyzer.

Many types of analyzers are used today in both industrial and non-industrial applications. Almost all of these analyzers can be divided into two categories, “continuous” and “non-continuous”. Continuous analyzers require a continuous flow of a gas sample through a analyzer measuring cell. This produces a continuous measurement or analysis of the sample stream. Continuous analyzers are typically used in applications such as stack monitors, ambient air monitors, process control, and environmental monitors.

Non-continuous analyzers, or batch analyzers, generally operate on a timed cycle. Usually, the sample is introduced into the analyzer at the beginning of the cycle and the analyzing takes place during the remainder of the cycle. The cycle times can vary from one minute or less for a fast cycle, to an hour or more for a slow cycle.

For an analyzer of either type to operate correctly, it should be calibrated and operated under the same conditions. These conditions include temperature, flow and pressure. Traditionally, the sample streams of prior art analyzers are collected into a closed vent header. The vent header typically either flows to atmosphere or back to the process. Allowing the analyzers to vent to atmosphere provided the analyzer measurement cell with a stable reference pressure. More stringent environmental regulations, however, make undesirable, if not illegal, to vent gas samples to the atmosphere. To avoid this, a common practice was to recapture the gas samples and properly disposed of them in an environmentally acceptable manner, such as by burning the samples in a flare header.

The recapture of the samples presents a problem in that the atmosphere no longer can be used to provide a stable downstream pressure, i.e. backpressure, to the analyzer measuring cell. When venting a sample to a flare header, for example, the backpressure created by the flare header commonly varies from 1 psig to 10 psig or more.

In the past, pumps and electronic controls have been used to maintain stable analyzer measurement cell pressure. These mechanical systems generally include centrifugal or positive displacement pumps that are used to produce a vacuum to draw gas samples from a vent header to which the samples are vented from analyzer measurement cells. An electronic controller and control valve are typically provided to measure and control the vent header pressure by controlling the gas flow into the pump and thus maintain a desired pressure in the vent header. These prior art mechanical systems are typically large and expensive, and require significant maintenance. Further, such systems can be slow to react to changing pressure changes thereby necessitating the use of large capacity tanks to absorb pressure spikes.

### SUMMARY OF THE INVENTION

The present invention provides a system and method that uses pneumatic control components for maintaining a stable pressure in a vent header that receives a process gas or gases from an upstream source, such as a process analyzer. Unlike prior art systems used to maintain pressure in an analyzer, pressure control can be effected without the need for pumps or sophisticated electronic controls to maintain a stable pressure. In addition, an economizer circuit can be used to greatly increase the operating efficiency of the system.

Accordingly, a system and method for maintaining pressure in a vent header when venting one or more process gases comprises an eductor having a pressure passage for receiving a motive gas, a discharge passage, a flow constrictor between the pressure passage and the discharge passage for speeding the flow of fluid past a suction opening, and a suction passage for connecting the suction opening to the vent header; and an eductor flow regulator for regulating the flow of the motive gas to the pressure passage as a function of pressure in the suction passage or the discharge passage.

In one embodiment, the eductor flow regulator includes a flow controller having a pilot pressure inlet for operative connection to the discharge passage of the eductor. The flow controller modulates the flow of the motive gas to the pressure passage of the eductor as a function of the pilot pressure. Preferably the flow controller is a volume boosting flow controller wherein a relatively low pressure pilot signal is converted to a proportionally higher output pressure.

In another embodiment, the eductor flow regulator includes a flow controller and a backpressure regulator. The flow controller includes a pilot pressure inlet for receiving a pilot pressure from the backpressure regulator that is operative to modulate the pilot pressure as a function of the pressure in the suction passage of the eductor. The backpressure regulator may include an inlet, an outlet and a reference pressure inlet for receiving a reference pressure corresponding to the pressure in the suction passage of the eductor. The inlet of the backpressure regulator is operatively connected to the pilot pressure source for modulating the pilot pressure supplied to the flow controller. The outlet of the backpressure regulator can be vented to the atmosphere or connected to the vent header, the latter permitting use of motive gasses that typically may not be vented to the atmosphere due to environmental concerns.

In a preferred embodiment, a pressure regulator is operatively connected to the vent header for regulating flow of a gas supply to the vent header to maintain a desired pressure in the vent header. A flow control valve can also be interposed between the vent header and the eductor for maintaining a desired flow rate at a given pressure differential between the vent header and the vacuum passage of the eductor. The discharge passage of the eductor can be operatively connected to a flare header for burning the gas samples.

The foregoing and other features of the invention will become apparent from the following detailed description when considered in conjunction with the annexed drawings.

### BRIEF DESCRIPTION OF THE DRAWINGS

FIG. 1 is a schematic diagram of a system for maintaining pressure and flow in a vent header including an eductor and a flow controller in accordance with the present invention.

FIG. 2 is a schematic diagram of a system for maintaining pressure and flow in a vent header including an eductor, a flow controller and a backpressure regulator in accordance with the present invention.

FIG. 3 is a cross-sectional view of a backpressure regulator that can be used with the system of FIG. 2 in accordance with the present invention.

### DETAILED DESCRIPTION

The present invention provides a system for maintaining pressure in a vent header when venting one or more process gases comprising an eductor and regulator for regulating supply of a motive gas to the eductor. More particularly, the eductor has a pressure passage to which pressurized gas, such as nitrogen, is supplied by the regulator. A suction passage of the eductor is connected to the vent header to which the process analyzer vents gas samples, while a discharge passage of the eductor is connected to a discharge header. In operation, the pressurized gas supplied to the eductor creates a vacuum at the suction passage of the eductor that draws gas samples from the vent header for discharge into the discharge header. To compensate for varying backpressure in the discharge header, the gas supplied to the eductor is modulated by the regulator in response to the pressure in the suction passage or the discharge passage to thereby maintain a constant vacuum at the suction passage of the eductor, and consequently a generally constant pressure in the vent header.

For example, if the backpressure in the discharge header increases thereby causing a decrease in the vacuum (i.e., an increase in pressure) at the suction passage, the pressure of the gas supplied to the eductor is increased to offset the decrease in vacuum at the suction passage. Conversely, if the backpressure in the discharge header decreases thereby increasing the vacuum (i.e., a decrease in pressure) at the suction passage, the pressure of the gas supplied to the eductor is decreased to offset the increase in vacuum at the suction passage. In this manner, the pressure in the vent header is maintained substantially constant.

In one exemplary embodiment, the regulator can include a flow controller having a pilot pressure port connected to the discharge passage for supplying a pilot pressure to the flow controller. The flow controller controls the flow of motive gas to the eductor as a function of pressure in the discharge passage.

In another exemplary embodiment, the regulator includes a flow controller and a backpressure regulator, herein also referred to as an economizer. A pilot pressure port of the flow controller receives a pilot pressure from a pilot pressure source that is modulated by the backpressure regulator. The backpressure regulator receives a reference signal from the suction passage of the eductor and is operative to modulate the pilot pressure supplied to the flow controller as a function of the pressure in the suction passage of the eductor.

The flow controller can be a volume boosting flow controller for converting a low pressure input to a high pressure output. For example, the flow controller can be configured to multiply a low pressure pilot pressure by a desired factor to achieve a high pressure output.

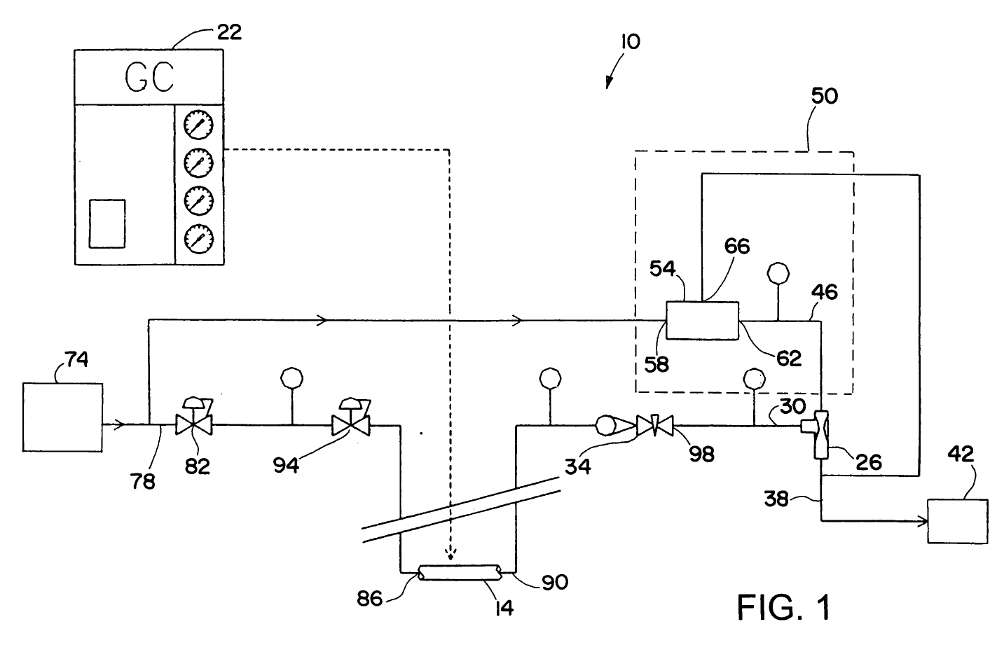

Referring now to the drawings in detail, and initially to FIG. 1, an exemplary system 10 for maintaining pressure and flow in a vent header 14 in accordance with the present invention is shown connected to a vent header 14 to which gas samples from a process analyzer 22 are discharged. The system 10 comprises an eductor 26 having a suction passage 30 operatively connected to the vent header 14 via a flow control valve, such as the illustrated rotameter 34. The eductor 26 includes a discharge passage 38 operatively connected to a discharge header 42, and a pressure passage 46 for receiving a motive gas for driving the eductor 26 to thereby create a vacuum in the suction passage 30. A regulator 50 is provided for regulating the flow of the motive gas to the pressure passage 46.

In the illustrated embodiment, the regulator 50 includes a flow controller 54 having an inlet 58 for receiving a motive gas, an outlet 62 for supplying the motive gas to the eductor pressure passage 46, and a pilot pressure inlet 66 for receiving a pilot pressure from a pilot pressure source. The pilot pressure source in the illustrated embodiment corresponds to the pressure in the discharge passage 38, and the pilot pressure inlet 66 of the flow controller 54 is connected thereto.

The flow controller 54 can be any suitable device for controlling flow. For example, the flow controller 54 can be a volume boosting flow controller wherein a relatively low pressure pilot signal is converted to a proportionally higher output pressure. Such a volume boosting flow controller can be equipped with a positive bias mechanism for maintaining a minimum flow through the flow controller regardless of the pilot pressure supplied thereto.

A gas supply 74 supplies gas to the system at two locations, an inlet 78 of the main control regulator 82 and the inlet 58 of the flow controller 54 for providing motive gas to drive the eductor 26. The main control regulator 82 is connected to a vent header control regulator 94 for maintaining generally constant pressure in the vent header 14, as will be described.

In general, the vent header 14 can be any suitable pipe or passage capable of receiving one or more gas samples from a process analyzer 22. The vent header 14 in the illustrated embodiment is connected to one or more measurement cells of a process analyzer 22 for venting gas samples therefrom. It will be appreciated that more than one process analyzer can vent to the vent header 14. For example, a single vent header could be used to vent samples from a plurality of analyzers in various locations of a factory or other facility.

The vent header 14 includes a gas supply inlet 86 and an outlet 90 which, as mentioned, is connected to the suction passage 30 of the eductor 26 via the rotameter 34. The vent header control regulator 94 regulates the pressure in the vent header 14 so as to maintain a generally constant pressure therein as varying amounts of gas samples are vented to the vent header 14 from the process analyzer 22. As will now be described, generally constant pressure and flow in the vent header 14 can be achieved by maintaining pressure in the vent header 14 with the pressure regulator 94 while maintaining a minimum vacuum pressure at the outlet 98 of the rotameter 34 to thereby maintain constant flow.

Accordingly, the pressure passage 46 of the eductor 26 is fed pressurized gas from the motive gas supply via the flow controller 54 to create a vacuum at the suction passage 30 of the eductor 26. As will be appreciated, the pressurized gas is fed to the eductor at a higher pressure than the backpressure at the discharge passage 38. The amount of pressurized gas supplied to the eductor 26 determines the strength of the vacuum created at the suction passage 30, and thus the pressure at the outlet 98 of the rotameter 34.

The rotameter 34 can be any desired size depending on the specific application. For example, the rotameter 34 can be sized and/or configured to allow a flow of 18 standard liters per minute (slpm) when a minimum vacuum pressure of 2.5 pounds per square inch gauge (psig) is supplied to the outlet 98 of the rotameter 34. As such, provided the vacuum pressure at the outlet 98 of the rotameter 34 supplied by the eductor 26 is greater than 2.5 psig, the rotameter 34 will allow a flow of 18 slpm from the vent header 14. If the vacuum pressure at the outlet 98 of the rotameter 34 were to drop below 2.5 psig, the pressure differential across the rotameter 34 may not be great enough to allow maximum flow of 18 slpm, and a reduced flow rate could occur. Therefore, as will be explained below, maintaining a minimum vacuum pressure at the outlet 98 of the rotameter 34 facilitates maintaining substantially constant flow through the vent header 14.

It will be appreciated that the rotameter 34 and eductor 26 are typically of a common capacity such that the eductor 26 can accommodate the maximum flow of the rotameter 34. In this case, both the rotameter 34 and eductor 26 are sized to flow 18 slpm. Depending on the application, the eductor 26 can be sized to handle more flow than the rotameter.

To facilitate understanding of the operation of the system 10, the system 10 will first be described in a steady-state condition wherein the flow of gas samples into the vent header 14 from the process analyzer 22 is constant and the discharge header 42 backpressure is constant. It will be appreciated that the eductor 26, rotameter 34, and other components can be sized and/or adjusted such that under a given set of operating conditions, the system 10 operates to maintain a desired pressure and flow in the vent header 14. In this example, the rotameter 34 is sized to allow 18 slpm flow rate and the eductor 26 is sized to handle a total flow of 18 slpm with a motive pressure of 90 psig while discharging into a backpressure of 20 psig. For the purpose of this description, the flow of gas samples from the process analyzer 22 will be considered constant at 10 slpm while the backpressure in the discharge header 42 is 10 psig. In this example, motive force pressure of 90 psi is supplied to the eductor 26 from the flow controller 54 to create a vacuum at the suction passage 30. The vacuum at the suction passage 30 creates the required low pressure on the outlet side 98 of the rotameter 34 to thereby allow full flow of 18 slpm through the vent header 14. The 18 slpm flow from the vent header 14 is comprised of the 10 slpm vented from the analyzer 22 and 8 slpm supplied by the vent header pressure regulator 94. It will be appreciated that should the flow rate of gas samples into the vent header 14 vary from 10 slpm, the vent header pressure regulator 94 would supply more or less flow to the vent header 14 to thereby maintain the 18 slpm flow rate from the vent header 14. In this steady-state example, the pressure and flow rate of the vent header 14 is generally maintained at 1″ water column and 18 slpm, respectively.

Unless the backpressure in the discharge passage 42 actually reaches 20 psig, supplying 90 psig motive pressure to the eductor 26 creates a vacuum at the suction passage 30 that is greater than necessary to produce the required vacuum pressure on the outlet 98 of the rotameter 34. As such, the eductor 26 is being “overdriven” and motive gas is wasted anytime the backpressure is less than 20 psig. To reduce the amount of wasted motive gas, the flow controller 54 is configured to modulate the flow of motive gas supplied to the eductor 26 as a function of the backpressure in the discharge passage 38 of the eductor 26.

As such, the pilot pressure inlet 66 of the flow controller 54 is connected to the discharge passage 38 for sensing the pressure in the discharge passage 38. The flow controller 54 is configured to increase the flow of motive gas to the eductor 26 when the backpressure in the discharge passage 38 increases, and decrease the flow of motive gas to the eductor 26 when the backpressure in the discharge passage 38 decreases. As mentioned, the flow controller can be a positive bias flow controller configured to supply a minimum motive gas pressure to the eductor 26. Thus, it will be appreciated that if the backpressure in the discharge passage increases, the flow controller 54 reacts by increasing the flow of motive gas to the eductor 26, thereby offsetting the increase in backpressure and maintaining a constant pressure at the suction passage 30. Conversely, when the backpressure returns to a normal level, the flow controller 54 reduces the flow of motive gas to the eductor 26 thereby offsetting the decrease in backpressure and maintaining a constant pressure at the discharge passage 38. Thus, it will now be appreciated that the illustrated embodiment enables the supply of motive gas to the eductor 26 to be controlled to mitigate overdriving the eductor 26 and thereby wasting motive gas.

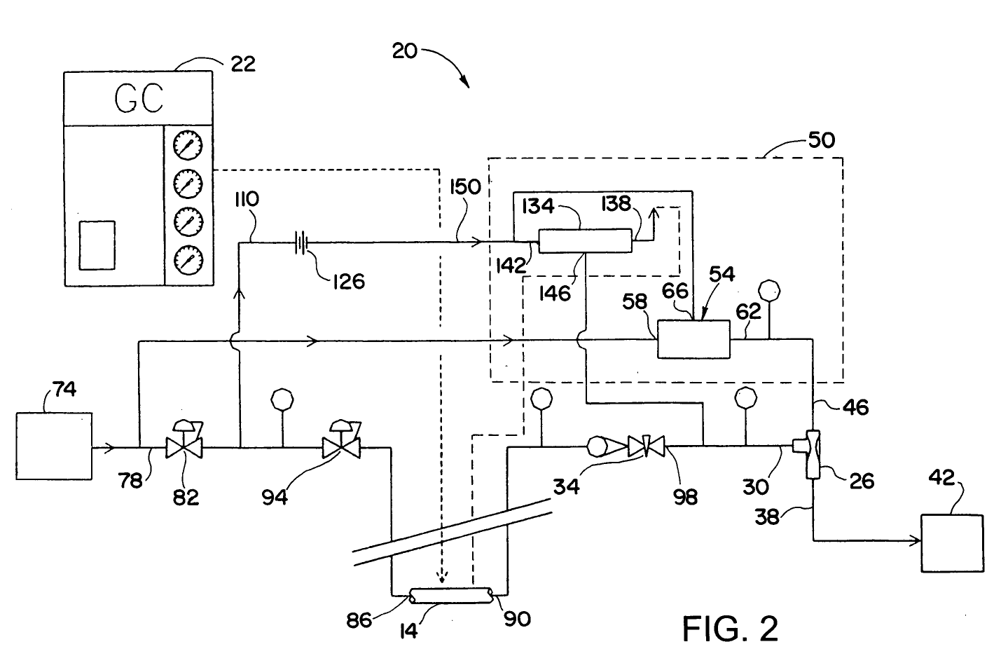

Turning to FIG. 2, another exemplary system 20 for maintaining pressure and flow in a vent header 14 is shown. The system 20 in FIG. 2 is similar to the system 10 in FIG. 1 except that the pilot pressure inlet 66 of the flow controller 54 is connected to a pilot pressure source 110 that is modulated by a backpressure regulator 134. The backpressure regulator 134 includes an inlet 138, an outlet 142, and a reference pressure inlet 146 for receiving a reference pressure from the suction passage 30 of the eductor 26. The inlet 138 of the backpressure regulator 134 is vented the atmosphere. The outlet 142 is operatively connected to the pilot pressure source 110 for modulating the pilot pressure supplied to the flow controller 54. As such, the backpressure regulator 134 is operative to modulate the pilot pressure supplied to the flow controller 54 from the gas supply 74 as a function of the pressure in the suction passage 30 of the eductor 26.

As in the embodiment shown in FIG. 1, the gas supply 74 in the embodiment of FIG. 2 supplies gas to the system at two locations, the inlet 78 of the main control regulator 82 and the inlet 58 of the flow controller 54 for providing motive gas to drive the eductor 26. The main control regulator 82 is connected to a vent header control regulator 94 and, separately, to the pilot pressure inlet 66 of the flow controller 54. A restricting orifice 126 is used to ensure a constant and controlled pilot pressure is provided. The vent header control regulator 94 regulates the flow of gas from the gas supply 74 to the vent header 14 to maintain constant pressure in the vent header 14 as described previously.

As mentioned, the backpressure regulator 134 modulates the pilot pressure supplied to the flow controller 54. In order to modulate the pilot pressure, the outlet 142 of the backpressure regulator 134 is connected to the pilot pressure line 150 leading from the restricting orifice 126 to the pilot pressure passage 66 of the flow controller 54. By controlling the flow of gas through the backpressure regulator 134 as a function of the pressure in the suction passage 30, the backpressure in the pilot pressure line 150 is thus modulated.

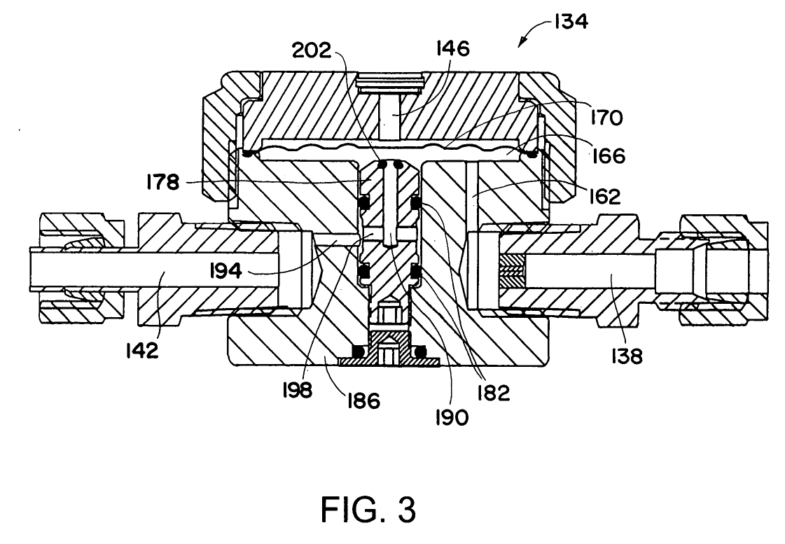

As seen in FIG. 3, an exemplary backpressure regulator 134 includes an inlet 138 and an outlet 142. The inlet 138 is connected by a port 162 to a chamber 166. The chamber 166 has a diaphragm 170 therein that is operable to restrict flow through the backpressure regulator 134. Reference port 146 can be connected to a reference pressure line for controlling the relative position of the diaphragm 170 and thus the flow of gas between the inlet 138 to the outlet 142. A threaded nozzle 178 through which gas flows is threaded into and sealed with seals 182 to body 186. The threaded nozzle 178 has bores 190 and 198 connecting the chamber 166 to bore 194 and the outlet 142 for passage of gas therethrough.

In a typical installation of the backpressure regulator 134, gas would be supplied to the inlet 138 and would flow into the chamber 166 through the threaded nozzle 178 to the outlet 158. The diaphragm 170 would regulate the flow of gas from the inlet 138 to the outlet 142 in response to the pressure at the pressure inlet 146. An increase in pressure at inlet 146 would deflect the diaphragm 170 downward thereby decreasing the flow of gas from the inlet 138 to the outlet 142. A decrease in pressure at inlet 146 would deflect the diaphragm upward thereby increasing flow from the inlet 138 to the outlet 142.

However, when installed in the system of FIG. 2, the backpressure regulator 134 preferably is connected “backwards” such that the outlet 142 of the backpressure regulator 134 is connected to the pilot pressure line 150 (FIG. 2). The inlet 138 of the backpressure regulator 134 vents to the atmosphere. In an alternative embodiment, the inlet 138 is connected to the vent header 14 for venting the pilot pressure thereto, as shown by the broken line in FIG. 2. The reference port 146 is connected to the suction passage 30 (FIG. 2) of the eductor 26. In this configuration, gas flows from the outlet 158 to the inlet 154 of the backpressure regulator 134.

In operation of the system 20 of FIG. 2, the backpressure regulator 134 vents the pilot pressure gas to the atmosphere under typical operating conditions. When the pressure increases downstream of the rotameter 34 resulting in an increase in the reference pressure supplied to the reference port 146 of the backpressure regulator 134, the diaphragm 170 senses the increase and is forced downward thereby tending to inhibit the flow of gas through the backpressure regulator 40 from the outlet 142 to the inlet 138, which in turn increases the pressure in the pilot pressure line 150 (FIG. 2). The increase in pilot pressure in pilot pressure line 150 causes the flow controller 54 to increase the flow of motive gas to the eductor 26 to thereby offset the increase in backpressure. Conversely, a decrease in pressure downstream of the rotameter 34 will result in the backpressure regulator 134 modulating the pilot pressure supplied to the flow controller 54 to thereby decrease the flow of motive gas to the eductor 26.

It will be appreciated that the present invention can be used with a wide variety of motive gasses, including gases that are not suitable for venting directly to the atmosphere, such as natural gas or propane. In addition, the present invention can be used to mitigate or eliminate waste of motive gas used to drive the eductor by automatically adjusting for changes in the backpressure of a discharge header, such as when venting to a flare header.

It will further be appreciated that the systems as described above can be used to maintain pressure and flow in a vent header at a range of desired values. As an example, it may be desirable to maintain the pressure of a vent header at atmospheric pressure while venting to a flare header. As such, it will be appreciated that the rotameter, eductor, and other components of the system can be sized and/or configured to maintain the pressure in the vent header at atmospheric pressure. Maintaining the vent header pressure at atmospheric pressure can be particularly advantageous for use in conjunction with process analyzers that are configured to vent to the atmosphere.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A system for maintaining pressure in a vent header when venting one or more process gases comprising an eductor having a pressure passage for receiving a motive gas, a discharge passage, a flow constrictor between the pressure passage and the discharge passage for speeding the flow of fluid past a suction opening, and a suction passage for connecting the suction opening to the vent header; and an eductor flow regulator for regulating the flow of the motive gas to the pressure passage as a function of pressure in the suction passage or the discharge passage.

2. A system as set forth in claim 1, wherein the eductor flow regulator comprises a flow controller and a backpressure regulator, the flow controller including a pilot pressure inlet for receiving a pilot pressure from a pilot pressure source, wherein the backpressure regulator is operative to modulate the pilot pressure supplied to the flow controller as a function of the pressure in the suction passage of the eductor.

3. A system as set forth in claim 2, wherein the flow controller includes an inlet for receiving a motive gas, an outlet for supplying the motive gas to the eductor pressure passage, and a pilot pressure inlet for receiving a pilot pressure from a pilot pressure source, the backpressure regulator including an inlet, an outlet, and a reference pressure inlet for receiving a reference pressure from the suction passage of the eductor, wherein the inlet of the backpressure regulator is operatively connected to the pilot pressure source for modulating the pilot pressure supplied to the flow controller.

4. A system as set forth in claim 2, wherein the outlet of the backpressure regulator is operatively connected to the vent header for discharging gas thereto.

5. A system as set forth in claim 1, wherein the eductor flow regulator comprises a flow controller for controlling the flow of the motive gas to the eductor pressure passage as a function of the pressure in the discharge passage.

6. A system as set forth in claim 4, wherein the a flow controller includes an inlet for receiving a motive gas, an outlet for supplying the motive gas to the eductor pressure passage, and a pilot pressure inlet operatively connected to the discharge passage of the eductor for providing a pilot pressure to the flow controller.

7. A system as set forth in claim 1, wherein the eductor flow regulator includes a volume booster operative to convert a low pressure pilot pressure related to the pressure at the suction passage or the discharge passage of the eductor to a high flow output.

8. A system as set forth in claim 1, further comprising a pressure regulator operatively connected to the vent header for regulating flow of a gas supply to the vent header to maintain a desired pressure in the vent header.

9. A system as set forth in claim 1, further comprising a flow control meter interposed between the vent header and the eductor for maintaining a desired flow rate at a given pressure differential between the vent header and the vacuum passage of the eductor.

10. A system as set forth in claim 1, wherein the discharge passage of the eductor is operatively connected to a flare header for burning the samples.

11. A system comprising at least one process analyzer and the system as set forth in claim 1.

12. A method for maintaining pressure in a vent header when venting one or more process gases using an eductor having a pressure passage for receiving a motive gas, a discharge passage, a flow constrictor between the pressure passage and the discharge passage for speeding the flow of fluid past a suction opening, and a suction passage for connecting the suction opening to the vent header, the method comprising the step of regulating the flow of the motive gas to the pressure passage as a function of pressure in the suction passage or the discharge passage.
